(19) United States
(12) Patent Application Publication
(10) Pub. No.: US 2012/0075477 A1
(43) Pub. Date: Mar. 29, 2012

(54) HANDHELD TERAHERTZ WAVE IMAGING SYSTEM

(76) Inventors: Robert Patrick Daly, Orlando, FL (US); Farrell Anthony Small, Sanford, FL (US)

(21) Appl. No.: 12/893,171

(22) Filed: Sep. 29, 2010

(51) Int. Cl. H04N 5/33

(52) U.S. Cl. 348/164; 348/E05.09

(57) ABSTRACT

A handheld terahertz wave imaging system is disclosed. In a particular embodiment, the system includes a housing adapted to be carried by an operator, a terahertz wave camera configured to process terahertz wave energy to detect concealed objects hidden on a target subject, and a hand operated control device to control the terahertz wave camera based on an operator input. Optics are mounted to the housing and configured to adjust a focus of the terahertz wave energy. The terahertz wave camera may have a three axis stage and a laser rangefinder to determine a distance to the target subject to assist in focusing the terahertz wave camera. Further, the handheld terahertz wave imaging system may include video goggles to display terahertz wave imagery generated from the terahertz wave energy.

### I. FIELD

The present invention relates in general to the field of concealed object detection systems using terahertz wave imagery, and in particular to a handheld terahertz wave imaging system.

### II. DESCRIPTION OF RELATED ART

A passive terahertz wave camera has the ability to detect and image objects hidden under clothing using terahertz wave imagery. The passive terahertz wave camera detects radiation that is given off by all objects. The technology works by contrasting the terahertz wave signature of the human body, which is warm and reflective, against that of a gun, knife or other contraband. Those objects appear darker or lighter because of the differences in temperature, hence, terahertz wave energy, between the human body and the inanimate objects. An object-based scene is generated for viewing on a video monitor with individual objects having spatial and temporal relationships. The objects may be created in any number of ways, including signals from a passive terahertz wave camera and/or signals from a visible spectrum video camera.

Harsh and uncontrolled environments require that the prior art terahertz wave camera must be adapted for each installation to provide the proper contrast between the environment and a subject so that the camera can detect concealed objects, which is expensive and time consuming. Further, personnel must be trained to operate the system for each different installation environment. Hence, a need exists in the art for a system for a handheld terahertz wave imaging system that simplifies training and ease of use by using a similar deployment for each application. A need also exists in the art for a handheld terahertz wave imaging system that eliminates the need to custom engineer the terahertz wave camera(s) to an uncontrolled environment.

Another shortcoming is that the prior art terahertz wave cameras are dependent on existing utilities and on-site support, which is not always available in a harsh environment. Accordingly, what is needed is a handheld terahertz wave imaging system that eliminates the need for services to support the terahertz wave camera such as air conditioning and an external power source.

Another need exists in the art for a handheld terahertz wave imaging system that provides a stable, standard platform for deployments across extremely variable environments, resulting in lower installation costs and time, and simpler construction and support due to the standardized methodology.

However, in view of the prior art at the time the present invention was made, it was not obvious to those of ordinary skill in the pertinent art how the identified needs could be fulfilled.

### III. SUMMARY

In a particular embodiment, a handheld terahertz wave imaging system is disclosed. The handheld terahertz wave imaging system includes a housing adapted to be carried by an operator, a terahertz wave camera configured to process terahertz wave energy to detect concealed objects hidden on a target subject, and a hand operated control device to control the terahertz wave camera based on an operator input. Optics are mounted to the housing and configured to adjust a focus of the terahertz wave energy. In addition, an amount by which the hand operated control device is moved corresponds to an amount of directional movement of the focus of the terahertz wave camera. The hand operated control device may be a joystick, for example. The terahertz wave camera may have a three axis stage and a laser rangefinder to determine a distance to the target subject to assist in focusing the terahertz wave camera. Further, the handheld terahertz wave imaging system may include a video monitor to display terahertz wave imagery generated from the terahertz wave energy.

The handheld terahertz wave imaging system is used to identify a target, determine a current distance to the target, focus the terahertz wave camera on the target, scan the terahertz wave energy of the target, and process the terahertz wave energy to generate terahertz wave imagery of the target. An operating frequency of the terahertz wave camera is between 300 GHz and 350 GHz and is effective between distances of approximately 4 m to 20 m.

One particular advantage provided by embodiments of the handheld terahertz wave imaging system is the highly portable design and construction. Deployment time is measured in minutes instead of hours or days. Another particular advantage provided by embodiments of the system is that the need to adapt the system's cameras to an uncontrolled environment is eliminated. In addition, the system can operate as either an entry portal for weapons or contraband detection or as an exit portal for theft prevention or both.

Another particular advantage provided by the embodiments of the handheld terahertz wave imaging system is the possibility of covert deployment, either by its rapid deployment nature or by concealing the camera by virtue of its portability and deployment requirements. Accordingly, the deployment of the system is completed without tools, simplifying and speeding deployment and re-deployment. Further, the system can be powered using an independent on-board battery supply so that deployment is possible away from standard utility service (e.g., in a field, forest, desert or hostile environment).

Another advantage provided by embodiments of the system is that operator video goggles allow the operator to view terahertz wave imagery and to continuously scan the scene for targets contemporaneously. The system selectively, automatically and intelligently utilizes computer software and algorithms to determine the target's distance, direction and relative motion.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a front perspective view of a particular embodiment of the handheld terahertz wave imaging system being worn by an operator;

FIG. 2 is a rear perspective view of the particular embodiment of the handheld terahertz wave imaging system of FIG. 1 being worn by the operator;

FIG. 3 is a rear perspective view of a particular embodiment of the handheld terahertz wave imaging system;

FIG. 4 is a front view of a particular embodiment of the handheld terahertz wave imaging system;

FIG. 5 is a side view of a particular embodiment of the handheld terahertz wave imaging system; and

FIG. 6 is a block diagram of a particular illustrative embodiment of the handheld terahertz wave imaging system.

### V. DETAILED DESCRIPTION

Terahertz wave cameras are detection devices that are operative to detect differences or contrast between terahertz wave energy (e.g., electromagnetic wave energy lying in the 300-350 GHz range) that is naturally emitted by the body of an individual and terahertz wave energy that is emitted, reflected, absorbed or otherwise attenuated by any object concealed on that individual. A standard visible spectrum CCD video camera is operative to produce continuous dynamic images on a real-time basis that relate spatially and temporally to the terahertz wave imagery.

The terahertz wave contrast-based imagery may be combined with the images of the individual produced by the visible spectrum CCD video camera to realize a set of composite images. Alternatively, the terahertz wave imagery and the visible spectrum imagery may be shown side-by-side on a display having a graphical user interface. The individual being scanned and also any concealed object(s) revealed by the contrast-based imagery that was generated in conjunction with the terahertz wave camera is displayed.

Software modules may implement instructions, which interface computer hardware, other software and external devices such as frame buffers, terahertz wave sensor controllers, hard disk drives and the like. Software modules may also be used to control, capture, digitalize and store the imagery from the visible spectrum camera and terahertz wave camera and to evaluate the resultant imagery, stored in a computer memory or other medium, as pixels.

The handheld terahertz wave imaging system may be easily carried by an operator. The system may be used outdoors and can be quickly relocated to any desired vantage point that may include behind impact attenuators, sandbags or natural geologic features (e.g., boulders, cliffs, etc.). A suitable location will include a direct line-of-site to one or more areas of interest. The system is self-contained and set-up time is approximately 15 minutes or less. Training time for an operator is approximately two to four hours. One operator is required for typical operations. Suitable communications may be provided locally to coordinate the system operator with other security personnel.

Once emplaced, the system is ready for operation. The system operator and/or other security personnel can view subjects (i.e., targets) of interest approach, either through channelized approaches or across an open space. The operator uses his/her vision to position the system in the direction of a target. A joystick may be used to manually aim and focus the system at the approaching target(s). A laser rangefinder may determine a distance to the target and automatically (or manually) optimizes the focus of the terahertz wave (“THW”) camera. The joystick manually controls the pan/tilt of the system. That information can then be displayed on goggles worn by the operator or on a display monitor, or any combination thereof. A CCD video camera may be used to display additional images corresponding to the terahertz wave imagery. The system scans the target in real time (e.g., 15 frames or greater per second) as soon as the target is in range and automatically processes the scanned image/video for suspicious objects and displays the results to the operator. The operator and other security personnel follow local security protocols as required in the event of a possible detection.

All images may be displayed in real-time. Weapons or objects concealed by targets in the surveillance zone may appear as contrasting shades of grey on the display. Automatic detection algorithms may isolate the target in question from other subjects outdoors and detect and indicate the concealed objects via computer-generated highlights overlaying graphical user interface (GUI) images. The laser rangefinder scans the field of view to create a range “image” that will allow the software to distinguish between humans, background and objects on the human. A trained operator viewing the THW image display may also make detections.

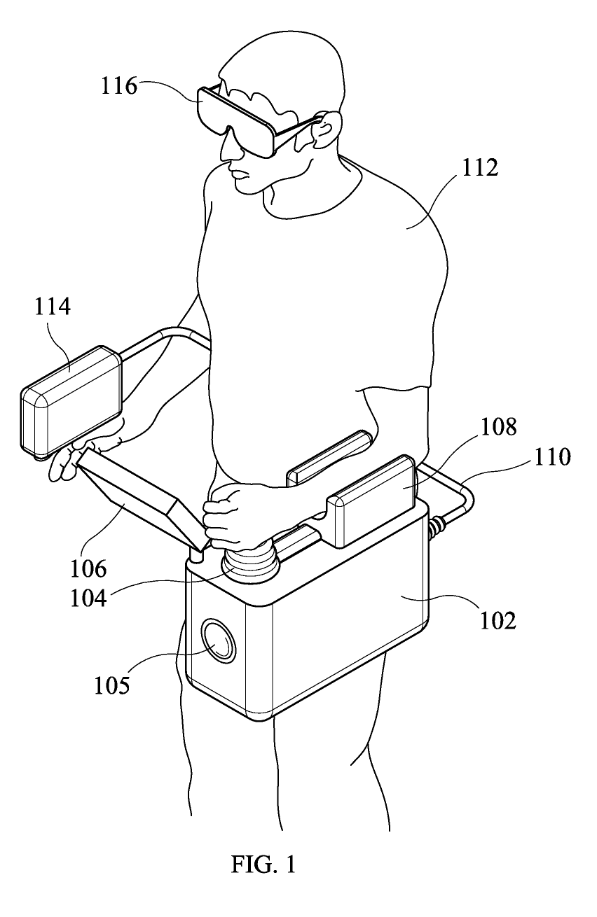

Referring now to FIG. 1, a particular illustrative embodiment of a handheld terahertz wave imaging system is disclosed. A housing 102 is used to contain a sensor array (i.e., terahertz wave camera) and other electronics for detecting and processing terahertz wave energy. Optics 105 are secured to a front portion of the housing 102 to focus terahertz wave energy from a target of interest. A display monitor 106 may be mounted to the housing and 102 and used to display the terahertz wave imagery to the operator 112. A corresponding visible spectrum image may be shown on the monitor 106 from a visible spectrum video camera (e.g., CCD camera) to correspond to the terahertz wave imagery. The images may be stored onto a memory device such as hard disk drive that may also be within the housing 102. In addition, a pair of video goggles 116 may be worn by the operator 112 to display the video images and terahertz wave imagery. The images may be encoded with a time stamp indicating the absolute or relative time the image was acquired or references such information by way of a data file or database structure. Each image may also be encoded with other data such as threat presence/absence, threat highlights, sensitivity levels, analysis masks, etc. or this data can be stored into a data file or database structure. A computer-generated visual cue, such as a rectangle, may define an area of a threat that was detected on the image. The system may also integrate imagery from additional dissimilar sources such as x-ray, microwave, infra-red and ultra-violet imagers. Also, the visible spectrum images and terahertz wave images may be displayed as overlays in the same window as a composite image with a user controlled opacity/translucency.

The operator 112 uses his/her vision and a laser rangefinder mounted at the front of the housing 102 to determine a distance to a target and to adjust the direction of the terahertz wave camera to find the desired target. The operator 112 places his arm into an arm rest 108 along the top of the housing 102 that helps to stabilize the system in operation. A joystick 104 may be used by the operator to manually adjust the focus of the terahertz wave camera.

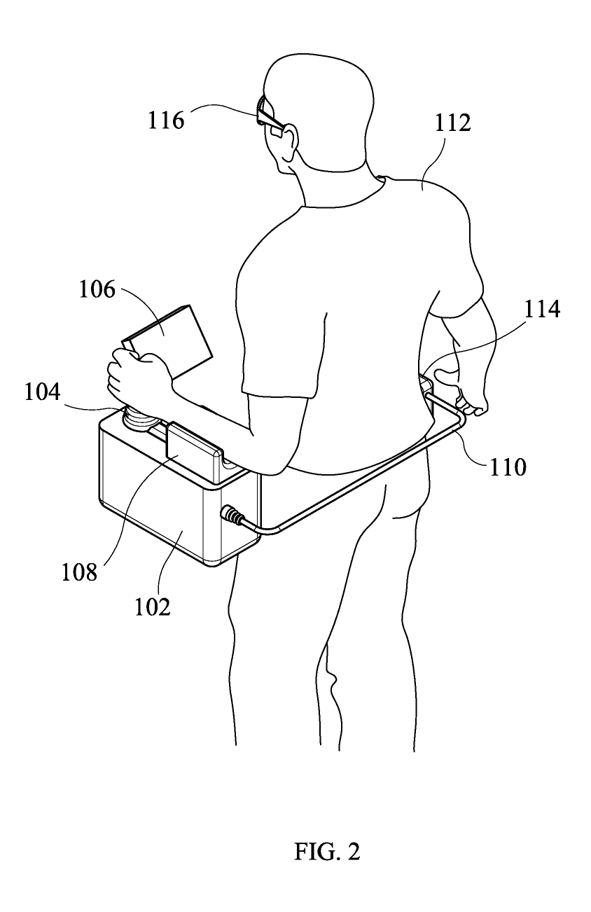

As best shown in FIG. 2, a rear support 110 wraps around the waist area of the operator 112 from the housing to a battery pack 114 on an opposing side of the operator 112. The rear support may be rigid and self supporting or flexible, similar to a belt, and be tightly secured or clipped to the operator 112.

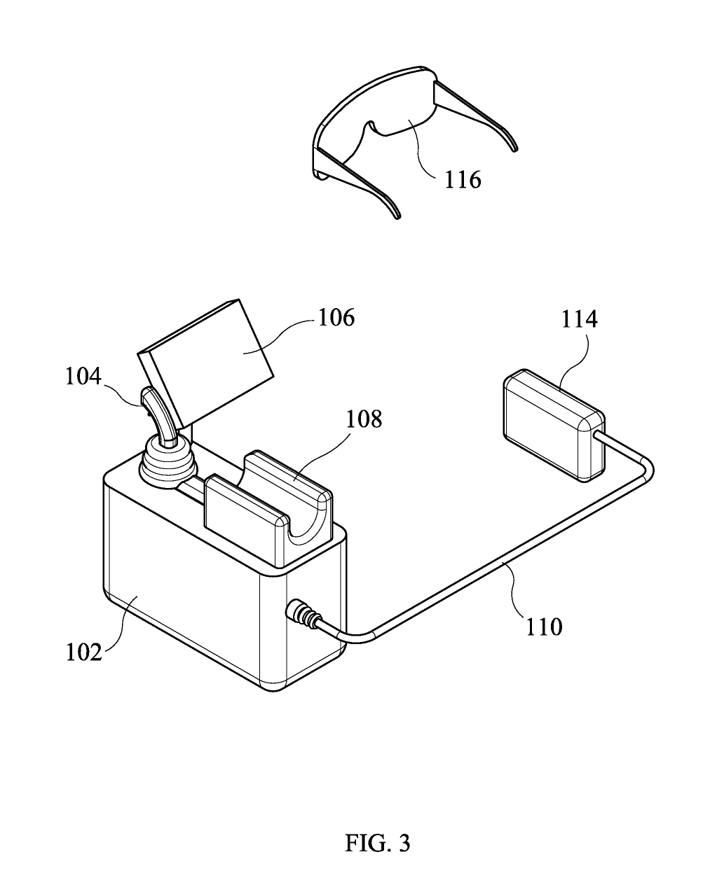

Referring now to FIG. 3, the housing 102 may be a generally rectangular shaped box. However, any shaped housing may be used. The display monitor 106 mounted to the housing 102 is adjustable to tilt and rotate to provide the best viewing angle to the operator or to other security personnel. The display monitor may also be removed from the housing to use separately for display of images. The display monitor may be turned off so that the operator is using only the video goggles 116 to find the target and to view the images. The goggles 116 allow the operator 112 to view the scene and the goggles 116 may be equipped with infrared or other night vision capabilities. Small video displays may be positioned within the goggles 116 to allow the operator 112 to view the images but does not completely block the vision of the operator 112. A wireless link may connect the goggles 116 to the system and eliminate the need for a hard wired connection. The arm rest 108 is generally U-shaped and adapted to receive and support a forearm of the operator 112 to provide stability when aiming the system at the target.

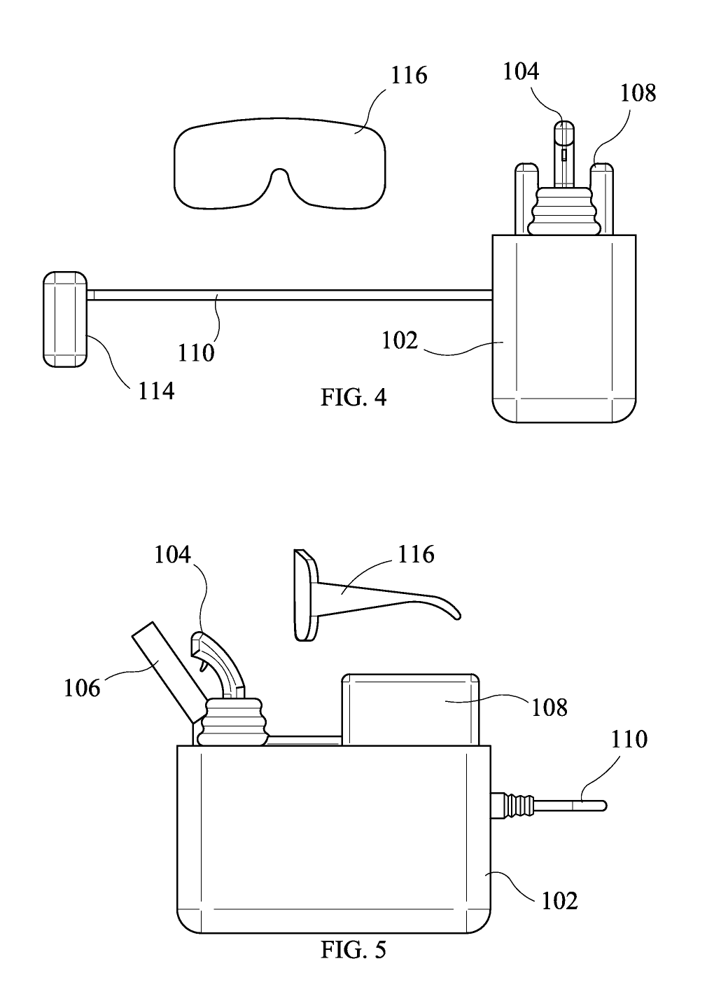

The optics 105 may be located on a front side of the housing 102 and are aligned with the joystick 104 of the system as shown in FIG. 4. A variable focus of the optics may be changed when viewing targets from a distance or to focus the terahertz wave camera to an area of interest. The optics 105 have the ability to dither and zoom in on a target subject. The battery pack 114 powers the system and may operate up to six hours and be hot swappable. The goggles 116 may be used with the system, as described above, to view terahertz wave imagery and to aim the system at a target. In addition, a laser rangefinder may be mounted to the front side of the housing to assist in automatic zoom. A variable focus of the optics may be changed from 26 m to 100 m when viewing targets from a distance or to focus the terahertz wave camera to an area of interest.

The operator 112 may be positioned approximately between 4 m and 20 m from a target and will need about 3 to 5 seconds to acquire and scan the target. When viewing a target distant from the operator 112, or to focus-into an area in question, the variable focus of the optics can be quickly changed via the joystick 104. A field of view of the system is approximately 1 m by 2 m meters at 10 m. The operator 112 can rotate his/her body and tilt forward or backwards to aim the system at the target. A strap may be provided that is adapted to slide over a shoulder of the operator 112 to carry the housing 102 at a front side of the operator 112. A weight of the system may be approximately 15 pounds.

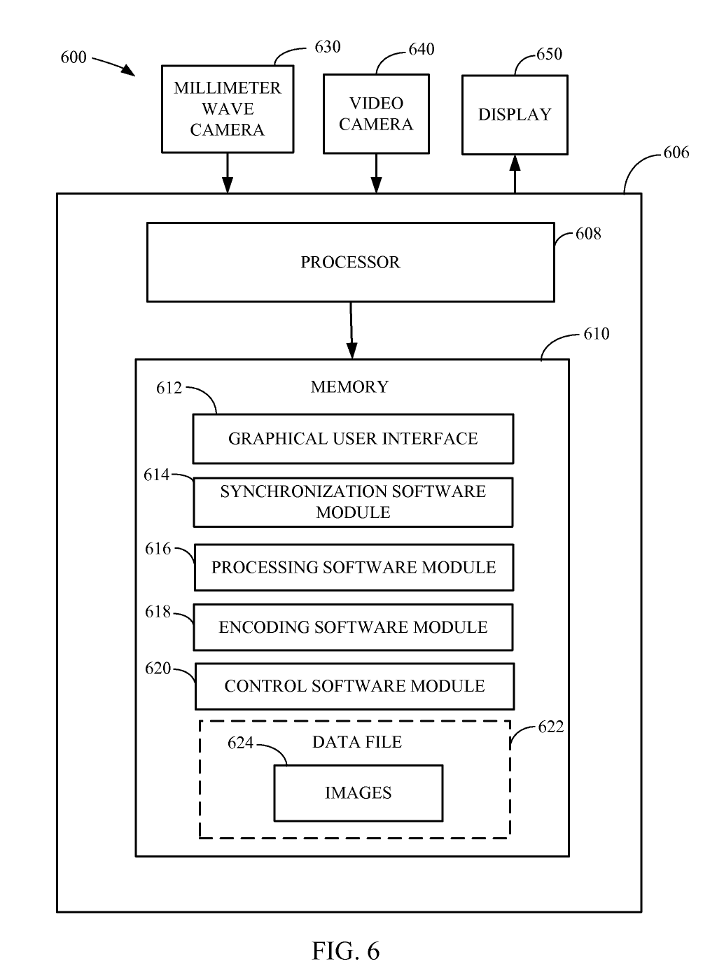

A block diagram of a particular embodiment of a handheld terahertz wave imaging system is disclosed in FIG. 6 and generally designated 600. The system 600 includes a device 606 having at least one processor 608 and a memory 610 that is accessible to the processor 608. The memory 610 includes media that is readable by the processor 608 and that stores data and program instructions of software modules that are executable by the processor 608, including a graphical user interface 612, a synchronization software module 614 for synchronizing the visible spectrum imagery with the terahertz wave imagery, a processing software module 616 for combining video imagery and terahertz wave imagery to generate composite images, an encoding software module 618 for encoding images with event data indicating a threat or recording into a datafile or database structure the indication of a threat, a control software module 620, and a data file 622 that may include recorded images 624. A terahertz wave camera 630, a video camera 640 and a display 650 are coupled to the device 606. In a particular embodiment, the graphical user interface 612 may include a keyboard, a pointing device, a touch screen, a speech interface, another device to receive user input, or any combination thereof.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

1. A handheld terahertz wave imaging system, the system comprising:
a housing adapted to be carried by an operator;
a terahertz wave camera configured to process terahertz wave energy to detect concealed objects hidden on a target subject; and
a hand operated control device to control the terahertz wave camera based on an operator input.

2. The handheld terahertz wave imaging system of claim 1, further comprising optics mounted to the housing and configured to adjust a focus of the terahertz wave energy.

3. The handheld terahertz wave imaging system of claim 2, wherein an amount by which the hand operated control device is moved corresponds to an amount of directional movement of the focus of the terahertz wave camera.

4. The handheld terahertz wave imaging system of claim 3, wherein the terahertz wave camera having a three axis stage.

5. The handheld terahertz wave imaging system of claim 3, further comprising a laser rangefinder to determine a distance to the target subject to assist in focusing the terahertz wave camera.

6. The handheld terahertz wave imaging system of claim 3, further comprising a pair of video goggles that are worn by the operator to display terahertz wave imagery generated from the terahertz wave energy.

7. The handheld terahertz wave imaging system of claim 3, further comprising a video monitor to display terahertz wave imagery generated from the terahertz wave energy.

8. The handheld terahertz wave imaging system of claim 7, further comprising a memory device for storing the terahertz wave imagery.

9. The handheld terahertz wave imaging system of claim 8, further comprising at least one visible spectrum video camera to generate video images spatially and temporally relative to the terahertz wave imagery.

10. A handheld terahertz wave imaging system, the system comprising:
a housing adapted to be carried by an operator;
a strap adapted to slide over a shoulder of the operator to carry the housing at a front side of the operator;
a sensor array within the housing to detect terahertz wave energy; and
a hand operated control device mounted to the housing to control the sensor array.

11. The handheld terahertz wave imaging system of claim 10, further comprising adjustable optics to dither and zoom in on a target subject.

12. The handheld terahertz wave imaging system of claim 11, wherein a focus of the sensor array correlates to a direction that the operator is facing.

13. The handheld terahertz wave imaging system of claim 12, further comprising a pair of operator goggles in electrical communication with the sensor array to view terahertz wave imagery.

14. The handheld terahertz wave imaging system of claim 13, further comprising a memory device for storing the terahertz wave imagery.

15. The handheld terahertz wave imaging system of claim 13, further comprising at least one battery to power the system.

16. The handheld terahertz wave imaging system of claim 15, further comprising an arm rest mounted to the top of the housing and adapted to stabilize an arm of the operator.

17. The handheld terahertz wave imaging system of claim 16, wherein an operating frequency of the sensor array is between 300 GHz and 350 GHz.

18. The handheld terahertz wave imaging system of claim 17, wherein a total viewable range of the sensor array is between 4 meters and 20 meters.

19. The handheld terahertz wave imaging system of claim 18, wherein a weight of the system is approximately 15 pounds.

20. The handheld terahertz wave imaging system of claim 19, wherein a field of view is approximately 1 meter by 2 meters at 10 meters.
